(19) United States
(12) Patent Application Publication
(10) Pub. No.: US 2011/0122066 A1
(43) Pub. Date: May 26, 2011

(54) KEYBOARD HAVING HANDWRITING PAD EMBEDDED THEREIN

(75) Inventor: LEI LIU, Shenzhen City (CN)

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/702,318

(22) Filed: Feb. 9, 2010

(30) Foreign Application Priority Data
Nov. 26, 2009 (CN) 200910310505.7

(51) Int. Cl. G06F 3/02

(52) U.S. Cl. 345/168

(57) ABSTRACT

A keyboard includes a casing defining a receiving groove therein, a plurality of keys mounted on the casing and a handwriting pad received in the receiving groove of the casing. The casing defines an opening at one side thereof. The opening is communicated with the receiving groove. In the casing, a pair of ribs are formed at two opposite sides of the receiving groove. A sliding groove and a sliding bar engaged with the sliding groove are respectively formed on each of two opposite sides of the handwriting pad and a corresponding one of the pair of ribs. The sliding bar is slidable received in the sliding grooves, and the handwriting pad is slidable in the receiving groove.

### BACKGROUND

1. Technical Field

The present disclosure relates to keyboards, and particularly to a keyboard having a handwriting pad embedded therein.

2. Description of Related Art

Generally, a keyboard of a computer is used to input information into the computer. However, people who use the keyboard to input information should know input methods, such as Pinyin input method and coding input method, which can be awkward for many people to use. Handwriting pads have been developed to solve this problem. A handwriting pad includes a touch screen on which users can write with a handwriting tool. The handwriting pad indentifies the tracks formed by the handwriting tool and then transforms them into information that can be recognized by the computer. The handwriting pad can replace the keyboard in many ways.

Since the handwriting pad is an additional accessory of the computer, users often buy a handwriting pad and connect it to the computer with a cable. However, the handwriting pad may occupy much space of a table on which the computer is located, which makes the table crowded. In addition, the exposed handwriting pad may accumulate dust on the touch screen of the handwriting pad.

Therefore, an improved keyboard is desired to overcome the above described shortcomings.

### BRIEF DESCRIPTION OF THE DRAWINGS

FIG. 1 is an assembled, isometric view of a keyboard in accordance with an exemplary embodiment.

FIG. 2 is an exploded, isometric view of the keyboard of FIG. 1.

FIG. 3 is another isometric view of the keyboard of FIG. 1, with a top cover removed and only a portion of the keyboard shown for clarity.

FIG. 4 is a partially assembled, isometric view of the keyboard of FIG. 2, showing the handwriting pad being mounted on the bottom plate.

FIG. 5 is an enlarged view of the circled portion V of FIG. 4.

FIG. 6 is similar to FIG. 1, showing the keyboard being in another state.

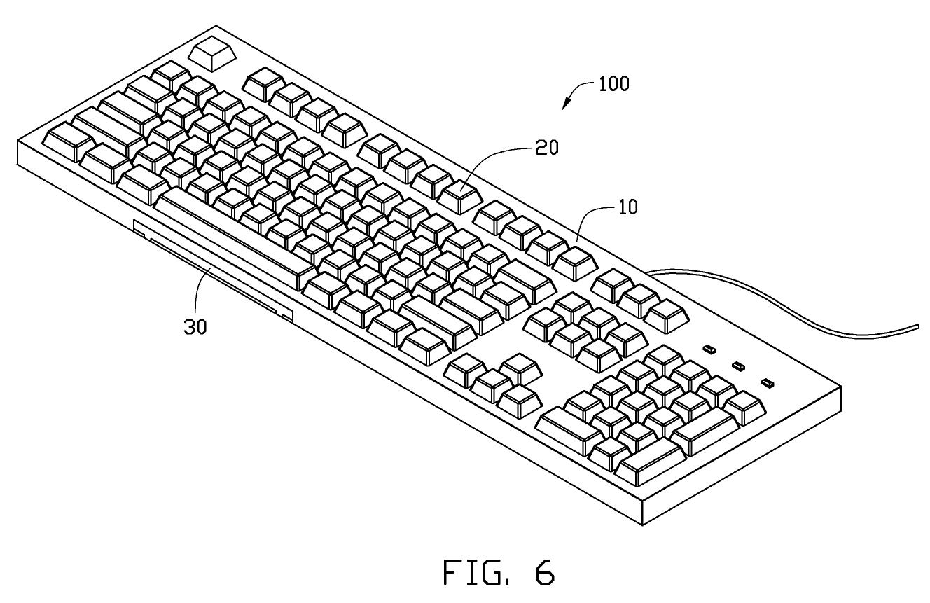

### DETAILED DESCRIPTION

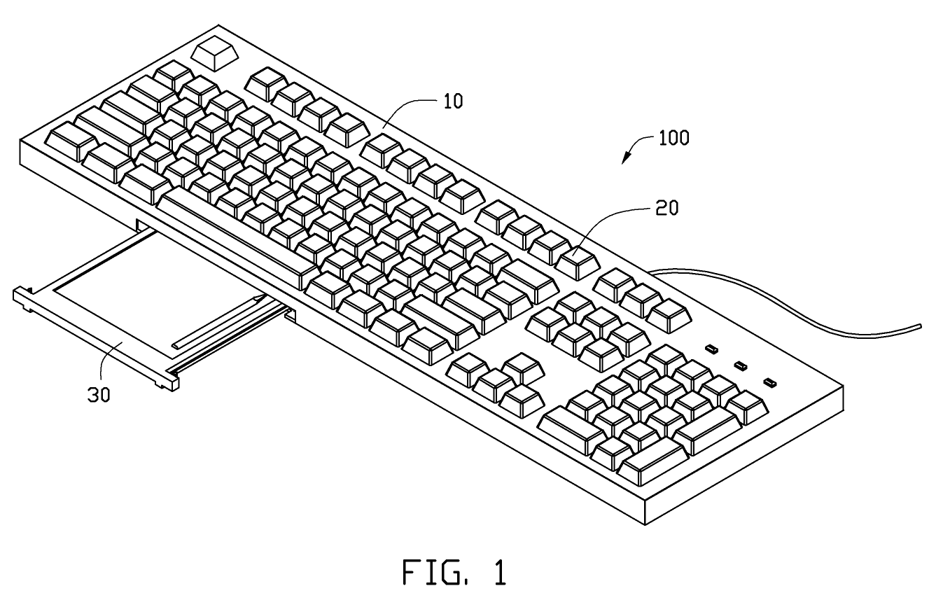

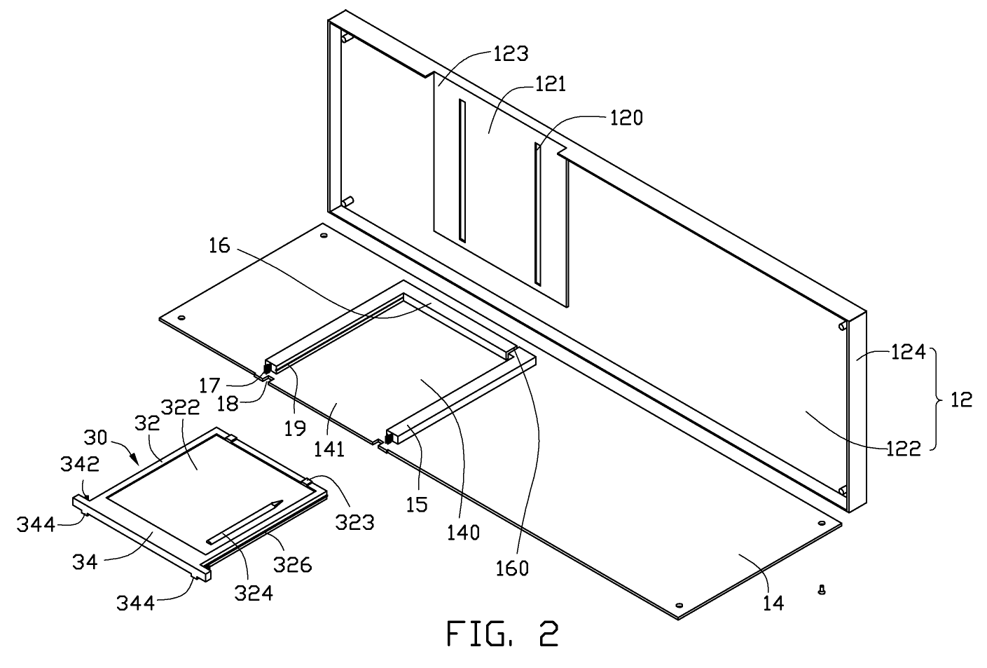

Referring to FIGS. 1 and 2, a keyboard 100 is shown. The keyboard 100 includes a casing 10, a plurality of keys 20 mounted on the casing 10 and a handwriting pad 30 received in the casing 10. The casing 10 includes a bottom plate 14 and a top cover 12 covering on the bottom plate 14. The top cover 12 includes a top plate 122 and a sidewall 124 extending downwardly towards the bottom plate 14 from an outer periphery of the top plate 122. The keys 20 are mounted on the top plate 122.

A raised surface 121 extends downwardly from a bottom surface of the top plate 122 near a front side of the top plate 122. The raised surface 121 is spaced from a rear side of the top plate 122, and has a square profile with two parallel elongated guiding grooves 120 defined therein. The guiding grooves 120 each are perpendicular to the front side of the top plate 122 and extend from the front side to the rear side of the top plate 122. The guiding grooves 120 extend from a front side of the raised surface 121 towards an opposite rear side of the raised surface 121. Two ends of each guiding groove 120 are spaced from the edges of the top plate 122. The sidewall 124 defines an elongated notch 123 at the front side of the top plate 122 corresponding to the raised surface 121.

The bottom plate 14 also has an rectangular shape, and is substantially the same size as the top plate 122. A pair of parallel first ribs 15 and a second rib 16 connect with the first ribs 15 are formed on the top surface of the bottom plate 14. The first ribs 15 and second rib 16 cooperatively define a receiving groove 140. The receiving groove 140 defines an opening 141 at the front side of the bottom plate 14. The second rib 16 is connected between the first ribs 15 and is arranged at the rear side of the bottom plate 14. The second rib 16 defines a slot 160 therein for receiving an extension of a cable (not shown) of the handwriting pad 30. Each first rib 15 defines an elongated sliding groove 19. The sliding groove faces the receiving groove 140. The front ends of the first ribs 15 are located near to but spaced away from the front edge of the bottom plate 14. The bottom plate 14 defines two cutouts 18 at the front edge of the bottom plate 14, corresponding to the front ends of the first ribs 15.

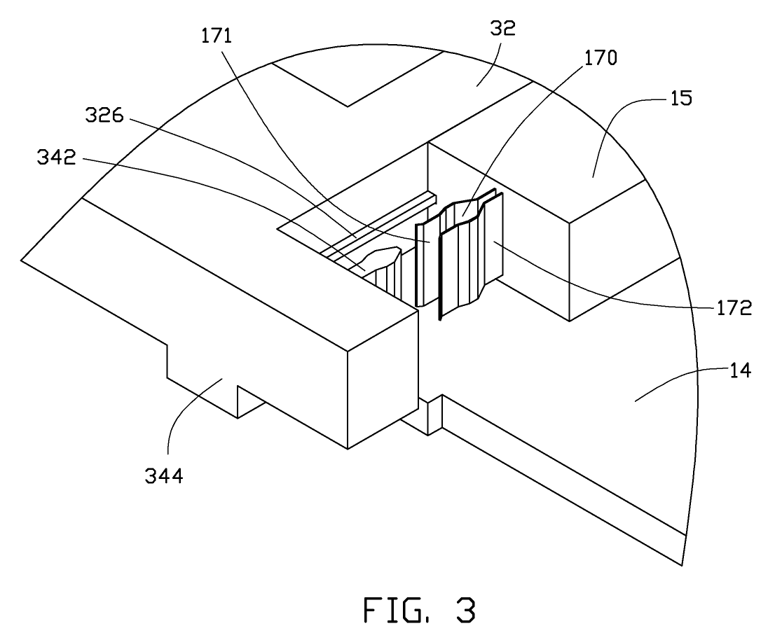

Referring also to FIG. 3, each first rib 15 forms a female engaging portion 17 at the front end thereof. The female engaging portion 17 consists of two snatches 172 spaced from each other with a receiving space 170 defined between the snatches 172. The snatches 172 are arranged in mirror symmetry and have the same shape and structure. The snatches 172 extend curvedly in such a manner that the width of the receiving space 170 latches between the two snatches 172 and decreases from the middle of the female engaging portion 17 toward each of the two ends of the female engaging portion 17. The female engaging portion 17 defines an entrance 171 at the front end, near the front edge of the bottom plate 14.

The handwriting pad 30 includes a main body 32 and a handle portion 34 connected to the front side of the main body 32. The main body 32 has a substantially square shape, and the size of the main body 32 of the handwriting pad 30 is equal to the receiving groove 140 in the casing 10. A touch screen 322 is formed on a central portion of an upper surface of the main body 32 of the handwriting pad 30. A handwriting tool 324 is received in a tool groove (not shown) defined in the main body 32 near the touch screen 322. Two cubic blocks 323 protrude upwardly from a rear side of the main body 32, corresponding to the two guiding grooves 120 of the top plate 122. The width of the block 323 is the same as that of the guiding groove 120 of the top plate 122 of the casing 10. Two sliding bars 326 are formed at two opposite lateral sides of the main body 32 of the handwriting pad 30 and match with the sliding grooves 19 of the first ribs 15. Alternatively, the sliding bars can be formed on the first ribs 15, and accordingly the sliding grooves match with the sliding bars are defined at two opposite lateral sides of the main body 32 of the handwriting pad 30.

The handle portion 34 has a width greater than that of the main body 32. Thus, two ends of the handle portion 34 protrude outwardly from the two lateral sides of the main body 32. Each end of the handle portion 34 forms a male engaging portion 342, and the male engaging portion 342 protrudes inwardly for matching with the female engaging portion 17 of the first ribs 15 of the bottom plate 14. The male engaging portion 342 has a solid profile and is in the form of a block. A width of the male engaging portion 342 increases from one end connected with the handle portion 34 to the middle of the male engaging portion 342, and then decreases from the middle to the free end of the male engaging portion 342 distant from the handle portion 34. Thus, the width of the middle of the male engaging portion 342 is greater than each of two ends of the male engaging portion 342. Two protrusions 344 are formed at a bottom side of the handle portion 34, corresponding to the two cutouts 18 of the bottom plate 14. The protrusions 344 protrude downwardly and each have a height substantially equaling the thickness of the bottom plate 14.

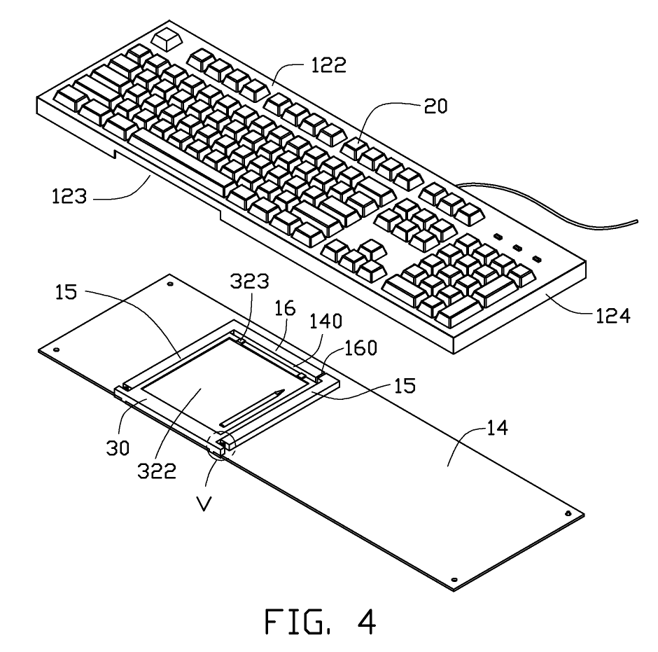

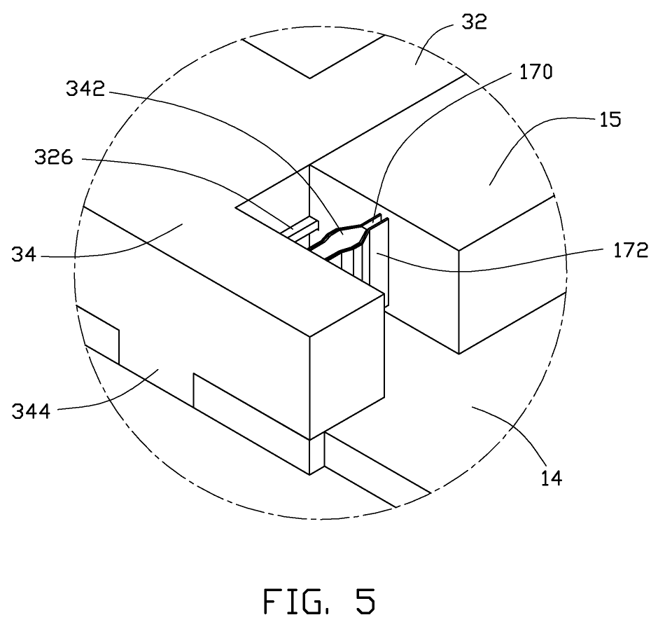

Referring to FIGS. 4 and 5, in assembly of the keyboard 100, the handwriting pad 30 enters into the receiving groove 140 from the opening 141, and the sliding bars 326 of the handwriting pad 30 are respectively engaged into and slidable in the sliding grooves 19 of the first ribs 15. The sliding bars 326 can slide along the sliding grooves 19 and thus allow the handwriting pad 30 to slide in and out of the receiving groove 140. Then the top cover 12 fittingly covers and is connected with the bottom plate 14 aligning the notch 123 of the sidewall 124 to correspond to the handwriting pad 30. The raised surface 121 of the top plate 122 is located above the handwriting pad 30. The blocks 323 of the handwriting pad 30 are respectively received in the guiding grooves 120 of the raised surface 121 of top plate 122 and slides in the guiding grooves 120.

When the handwriting pad 30 is in use, the handwriting pad 30 is pulled out of the casing 10 with the sliding bars 326 of the handwriting pad 30 sliding in the sliding grooves 19 of the first ribs 15 and the blocks 323 of the handwriting pad 30 thus, gliding in the guiding grooves 120. However, when the handwriting pad 30 is entirely pulled out, the blocks 323 move to the front end of the guiding groove 120. The blocks 323 abut against the top plate 122 at the front end of the guiding groove 120, thus limiting a further outward movement of the handwriting pad 30. Accordingly, a separation of the handwriting pad 30 from the casing 10 is avoided. The protrusions 344 of the handwriting pad 30 are supported on a table, thereby facilitating the users for using the handwriting pad 30.

When the handwriting pad 30 is not in use, the handwriting pad 30 can be pushed into the receiving groove 140 in such a way that the handwriting pad 30 is prevented from collecting dust. When the handwriting pad 30 is pushed into the receiving groove 140, the male engaging portions 342 of the handwriting pad 30 meet with the female engaging portions 17 of the first ribs 15, and the male engaging portion 342 enters and is engaged in the receiving space 170 of the female engaging portion 17 from the entrance 171. Since the width of the middle of the male engaging portion 342, is greater than the width of the entrance 171 of the receiving space 170. The middle of the male engaging portion 342 expands the snatches 172 outwardly and the entrance 171 of the female engaging portion 17 is thus widened for facilitating the male engaging portion 342 to enter into the receiving space 170 from the entrance 171.

After the male engaging portion 342 enters into the entrance 171 of the female engaging portion 17, the male engaging portion 342 fittingly engages in the receiving space 170 of the female engaging portion 17. Thus, a movement of the male engaging portion 342 out of the receiving space 170 of the female engaging portion is limited. The handwriting pad 30 is prevented from separating from the receiving groove 140 unless the handwriting pad 30 is pulled out by users.

When the handwriting pad 30 is fully received in the receiving groove 140, the protrusions 344 are received in the cutouts 18 of the bottom plates 14. The handle portion 34 of the handwriting pad 30 is located at the notch 123 of the sidewall 124 of the casing 10, and an outer surface of the handle portion 34 of the handwriting pad 30 is coplanar with the sidewall 124 of the casing 10. Thus, the handwriting pad 30 does not occupy any space on the table where the keyboard 100 is located.

It is to be understood, however, that even though numerous characteristics and advantages of the exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A keyboard, comprising:
a casing with a plurality of keys mounted thereon, the casing defining a receiving groove therein and an opening at one side thereof, the opening being communicated with the receiving groove, a pair of ribs formed at two sides of the receiving groove; and
a handwriting pad received in the receiving groove; wherein
a sliding groove and a sliding bar engaged with the sliding groove are respectively formed on each of two opposite sides of the handwriting pad and a corresponding one of the pair of ribs, the sliding bar is received and slidable in the sliding groove, and the handwriting pad is slidable in the receiving groove.

2. The keyboard of claim 1, wherein the casing forms a raised surface above the receiving groove, and the raised surface defines a guiding groove therein, the handwriting pad forming a block thereon corresponding to the guiding groove, the block being slidable in the guiding groove, when the handwriting pad is pulled out, the block abuts against the casing at one end of the guiding groove to limit a further outward movement of the handwriting pad from the casing.

3. The keyboard of claim 1, wherein the casing comprises a bottom plate on which the handwriting pad is mounted and a top cover covering the bottom plate.

4. The keyboard of claim 1, wherein the casing includes another rib connected with said ribs, wherein the bottom plate, said ribs and the another rib cooperatively define the receiving groove.

5. The keyboard of claim 4, wherein the another rib defines a slot therein for receiving an extension of a cable of the handwriting pad.

6. The keyboard of claim 1, wherein the sliding bar is formed at each of the two sides of the handwriting pad, and the sliding groove is defined in each of the ribs.

7. The keyboard of claim 1, wherein a female engaging portion is formed on each of the ribs, and the handwriting pad forms a male engaging portion match with the female engaging portion of each of the ribs, the male engaging portion of the handwriting pad engages in the female engaging portion when the handwriting pad is fully received in the receiving groove to prevent the handwriting pad from separating from receiving groove of the casing.

8. The keyboard of claim 7, wherein the handwriting pad includes a main body and a handle portion connected to one side of the main body, the handle portion having a width greater than that of the main body such that two ends of the handle portion protrude out of the two sides of the handwriting pad, the male engaging portion being located at each of the two ends of the handle portion of the handwriting pad.

9. The keyboard of claim 8, wherein the female engaging portion includes a pair of snatches spaced from each other with a receiving space defined between the snatches, the receiving space having a width decreasing from a middle towards each of two ends thereof.

10. The keyboard of claim 8, wherein the handle portion of the handwriting pad forms a protrusion at a bottom surface thereof for supporting the handwriting pad when the handwriting pad is pulled out of the casing.

11. The keyboard of claim 10, wherein the casing defines a cutout at one side thereof for receiving the protrusion of the handwriting pad when the handwriting pad is fully received in the receiving groove of the casing.
